(19) United States
(12) Patent Application Publication
(10) Pub. No.: US 2026/0148036 A1
(43) Pub. Date: May 28, 2026

(54) GENERATING TRANSPORTATION NETWORK SOLUTIONS USING GRAPH NEURAL NETWORKS

(71) Applicant: INTERNATIONAL BUSINESS MACHINES CORPORATION, ARMONK, NY (US)

(72) Inventors: DENG XIN LUO, XIAN (CN); RUI HAN, XIAN (CN); YU ZUI YOU, NINGBO (CN); JUN GUO, XIAN (CN); SEN LIANG, XIAN (CN); YI MING WANG, XIAN (CN); MU DAN CAO, BEIJING (CN)

(21) Appl. No.: 18/956,854

(22) Filed: Nov. 22, 2024

(51) Int. Cl. G06N 3/042

(52) U.S. Cl. CPC G06N 3/042

(57) ABSTRACT

Generating transportation network solutions using graph neural networks, includes: generating, based on input data describing a product transportation network, a graph neural network representing the product transportation network, wherein the graph neural network comprises multiple edges, multiple source nodes, multiple destination nodes, and multiple intermediary nodes; performing a graph neural network prediction based on the graph neural network, wherein performing the graph neural network prediction comprises predicting inclusion in the transportation network solution for each edge and intermediary node; and generating a transportation network solution by performing a model optimization using an initial state based on the graph neural network prediction.

### BACKGROUND

The present disclosure relates to artificial intelligence and transportation planning.

### SUMMARY

According to embodiments of the present disclosure, various methods, apparatus and products for generating transportation network solutions using graph neural networks are described herein. In some aspects, generating transportation network solutions using graph neural networks includes generating, based on input data describing a product transportation network, a graph neural network representing the product transportation network, wherein the graph neural network comprises multiple edges, multiple source nodes, multiple destination nodes, and multiple intermediary nodes; performing a graph neural network prediction based on the graph neural network, wherein performing the graph neural network prediction comprises predicting inclusion in the transportation network solution for each edge and intermediary node; and generating a transportation network solution by performing a model optimization using an initial state based on the graph neural network prediction. In some aspects, a computer system may include: a processor set; one or more computer-readable storage media; and program instructions stored on the one or more storage media to cause the processor set to perform operations including this method. In some aspects, a computer program product may include: one or more computer-readable storage media; and program instructions stored on the one or more storage media to perform operations comprising this method.

### BRIEF DESCRIPTION OF THE DRAWINGS

FIG. 1 sets forth a block diagram of an example computing environment for generating transportation network solutions using graph neural networks in accordance with some embodiments of the present disclosure.

FIG. 2 sets forth a diagram of an example product distribution network in accordance with some embodiments of the present disclosure.

FIG. 3 sets forth a diagram of an example graph neural network representation of a product transportation network for generating transportation network solutions using graph neural networks in accordance with some embodiments of the present disclosure.

FIG. 4 sets forth a diagram of an example graph neural network prediction for generating transportation network solutions using graph neural networks in accordance with some embodiments of the present disclosure.

FIG. 5 sets forth a diagram of an example pruned model for generating transportation network solutions using graph neural networks in accordance with some embodiments of the present disclosure.

FIG. 6 sets forth a flowchart of an example method for generating transportation network solutions using graph neural networks in accordance with some embodiments of the present disclosure.

### DETAILED DESCRIPTION

In some aspects, a method of generating transportation network solutions using graph neural networks includes: generating, based on input data describing a product transportation network, a graph neural network representing the product transportation network, wherein the graph neural network comprises multiple edges, multiple source nodes, multiple destination nodes, and multiple intermediary nodes; performing a graph neural network prediction based on the graph neural network, wherein performing the graph neural network prediction comprises predicting inclusion in the transportation network solution for each edge and intermediary node; and generating a transportation network solution by performing a model optimization using an initial state based on the graph neural network prediction. This provides the advantage of reducing the overall computational complexity in generating transportation network solutions using model optimizations.

In some aspects, the multiple intermediary nodes each interconnect a respective subset of the multiple source nodes to a respective subset of the multiple destination nodes. This provides the technical advantage of including intermediary stops between product sources and destinations in the model, thereby providing a more accurate representation of the product transportation network.

In some aspects, generating the graph neural network comprises assigning multiple node features and multiple edge features based on the input data. This provides the advantage of including various attributes of the product transportation network in the graph neural network to generate a more accurate graph neural network prediction.

In some aspects, the multiple node features comprise one or more product demands for one or more of the multiple destination nodes. This provides the advantage of having the transportation network solution reflect the particular demand of each product recipient.

In some aspects, the multiple node features comprise one or more produced products for the multiple source nodes. This provides the advantage of having the transportation network solution reflect the production capabilities of each product source.

In some aspects, the multiple node features comprise one or more capacity limits for one or more of the multiple intermediary nodes. This provides the advantage of having the transportation network solution reflect the product capacities for each product intermediary.

In some aspects, the multiple edge features comprise transportation route attributes for the multiple edges. This provides the advantage of having the transportation network solution reflect the particular attributes of each available transportation route.

In some aspects, the model optimization is based on an objective function. This provides the advantage of defining particular criteria to be optimized when performing the model optimization.

In some aspects, the model optimization is based on one or more constraints. This provides the advantage of requiring the transportation network solution to satisfy the particular demands or requirements by various entities in the product transportation network.

In some aspects, a computer system may include: a processor set; one or more computer-readable storage media; and program instructions stored on the one or more storage media to cause the processor set to perform operations comprising: generating, based on input data describing a product transportation network, a graph neural network representing the product transportation network, wherein the graph neural network comprises multiple edges, multiple source nodes, multiple destination nodes, and multiple intermediary nodes; performing a graph neural network prediction based on the graph neural network, wherein performing the graph neural network prediction comprises predicting inclusion in the transportation network solution for each edge and intermediary node; and generating a transportation network solution by performing a model optimization using an initial state based on the graph neural network prediction. This provides the advantage of reducing the overall computational complexity in generating transportation network solutions using model optimizations.

In some aspects, the multiple intermediary nodes each interconnect a respective subset of the multiple source nodes to a respective subset of the multiple destination nodes. This provides the technical advantage of including intermediary stops between product sources and destinations in the model, thereby providing a more accurate representation of the product transportation network.

In some aspects, generating the graph neural network comprises assigning multiple node features and multiple edge features based on the input data. This provides the advantage of including various attributes of the product transportation network in the graph neural network to generate a more accurate graph neural network prediction.

In some aspects, the multiple node features comprise one or more product demands for one or more of the multiple destination nodes. This provides the advantage of having the transportation network solution reflect the particular demand of each product recipient.

In some aspects, the multiple node features comprise one or more produced products for the multiple source nodes. This provides the advantage of having the transportation network solution reflect the production capabilities of each product source.

In some aspects, the multiple node features comprise one or more capacity limits for one or more of the multiple intermediary nodes. This provides the advantage of having the transportation network solution reflect the product capacities for each product intermediary.

In some aspects, the multiple edge features comprise transportation route attributes for the multiple edges. This provides the advantage of having the transportation network solution reflect the particular attributes of each available transportation route.

In some aspects, the model optimization is based on an objective function. This provides the advantage of defining particular criteria to be optimized when performing the model optimization.

In some aspects, the model optimization is based on one or more constraints. This provides the advantage of requiring the transportation network solution to satisfy the particular demands or requirements by various entities in the product transportation network.

In some aspects, a computer program product may include: one or more computer-readable storage media; and program instructions stored on the one or more storage media to perform operations comprising: generating, based on input data describing a product transportation network, a graph neural network representing the product transportation network, wherein the graph neural network comprises multiple edges, multiple source nodes, multiple destination nodes, and multiple intermediary nodes; performing a graph neural network prediction based on the graph neural network, wherein performing the graph neural network prediction comprises predicting inclusion in the transportation network solution for each edge and intermediary node; and generating a transportation network solution by performing a model optimization using an initial state based on the graph neural network prediction. This provides the advantage of reducing the overall computational complexity in generating transportation network solutions using model optimizations.

In some aspects, the multiple intermediary nodes each interconnect a respective subset of the multiple source nodes to a respective subset of the multiple destination nodes. This provides the technical advantage of including intermediary stops between product sources and destinations in the model, thereby providing a more accurate representation of the product transportation network.

In some aspects, generating the graph neural network comprises assigning multiple node features and multiple edge features based on the input data. This provides the advantage of including various attributes of the product transportation network in the graph neural network to generate a more accurate graph neural network prediction.

The layout of a product transportation network may include many entities, including plants, distributors, and dealers, that are interconnected using various transportation routes. Determining an optimal solution (e.g., with respect to some objective function) for transporting products along this product transportation network may be computationally expensive, particularly as the number of entities and routes increases. Accordingly, it may require a prohibitively long amount of time or prohibitively large amounts of computational resources to compute such a solution.

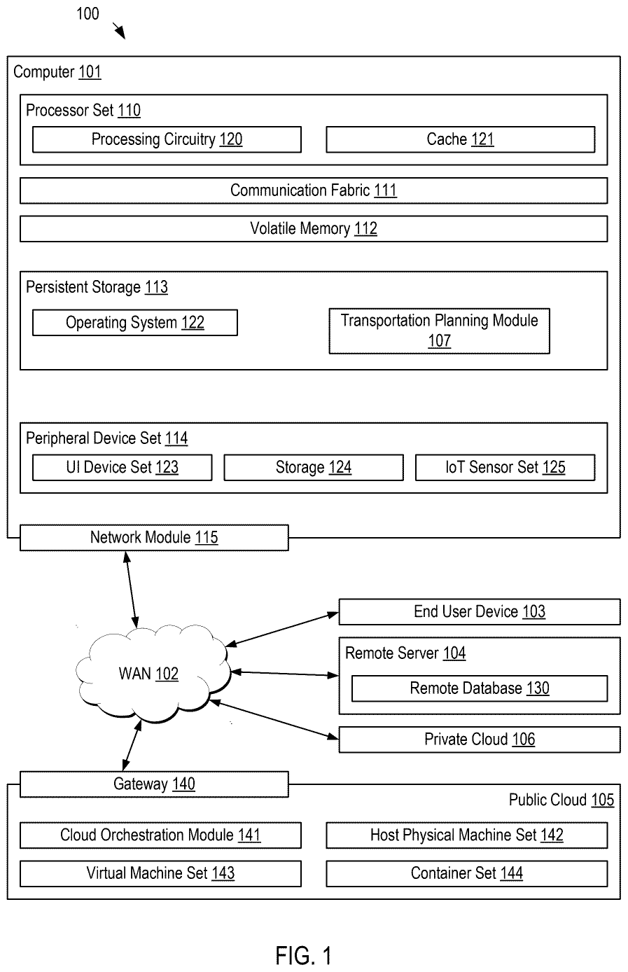

With reference now to FIG. 1, shown is an example computing environment according to aspects of the present disclosure. Computing environment 100 contains an example of an environment for the execution of at least some of the computer code involved in performing the various methods described herein, such as the transportation planning module 107. In addition to block 107, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 107, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document. These computer readable program instructions are stored in various types of computer readable storage media, such as cache 121 and the other storage media discussed below. The program instructions, and associated data, are accessed by processor set 110 to control and direct performance of the computer-implemented methods. In computing environment 100, at least some of the instructions for performing the computer-implemented methods may be stored in block 107 in persistent storage 113.

Communication fabric 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 107 typically includes at least some of the computer code involved in performing the computer-implemented methods described herein.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database), this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the computer-implemented methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

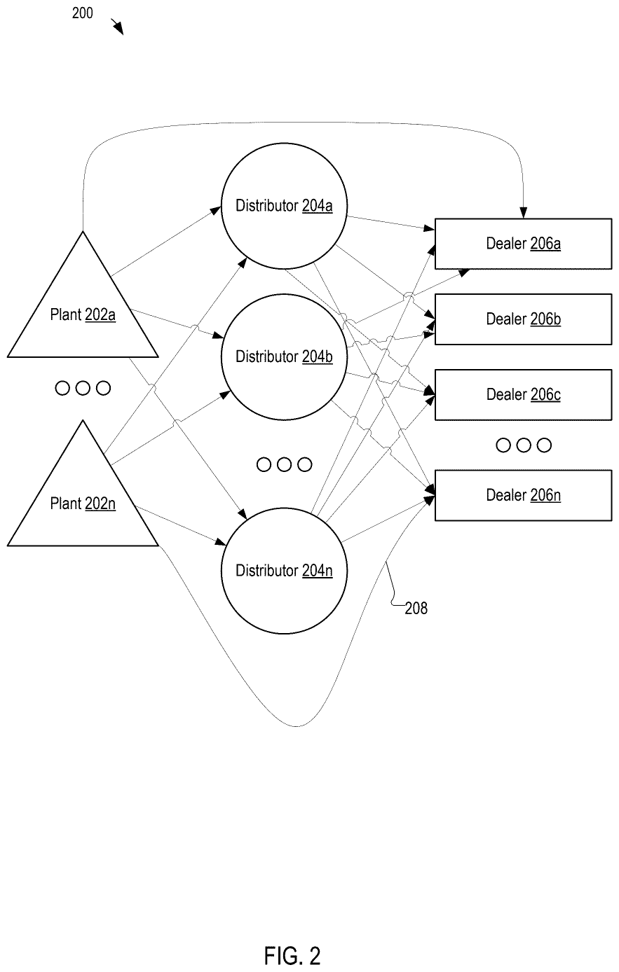

FIG. 2 sets forth a diagram of an example product distribution network 200 in accordance with some embodiments of the present disclosure. Particularly, the example product distribution network 200 sets forth a generalized diagram of the relationships (e.g., transportation routes) between plants 202a-n, distributors 204a,b-n, and dealers 206a,b, c-n. The example product distribution network 200 includes multiple plants 202a-n. Each plant 202a-n may include a location at which a product is manufactured, assembled, or otherwise originates prior to distribution. In other words, each plant 202a-n may include a source of one or more products and/or brands of products.

The example product distribution network 200 also includes multiple distributors 204a, b-n. Each distributor 204 a,b-n may include a respective location to which products are delivered from a plant 202a-n prior to delivery to a dealer 206a,b, c-n. Accordingly, each distributor 204a,b-n serves as an intermediary between one or more of the plants 202a-n and one or more of the dealers 206a,b, c-n. The example product distribution network 200 also includes multiple dealers 206a,b, c-n. Each of the dealers 206a,b, c-n serves as a destination for one or more products received from either a distributor 204a,b-n or directly from a plant 202a-n. Although the following discussion describes product transportation networks as including plants 202a-n, distributors 204a,b-n, and dealers 206a,b, c-n, readers will appreciate that the approaches set forth herein are also applicable to other product sources, intermediaries, and recipients, respectively.

The example product distribution network also includes multiple routes 208. Each route 208 includes a transportation route between a plant 202a-n and a distributor 204a,b-n, a plant 202a-n and a dealer 206a,b, c-n, or a distributor 204a,b-n and a dealer 206a,b, c-n. In some embodiments, a given pair of entities may be linked by potentially multiple routes 208, such as where those entities are linked by multiple modes of transportation. As shown, there may be multiple possible paths between plants 202a-n, distributors 204a,b-n, and dealers 206a,b, c-n to transport products due to these multiple interconnecting routes 208. Accordingly, a transportation network solution should be planned that defines which products from which plants 202a-n are transported to which dealers 206a,b, c-n through which routes and, if applicable, which distributors 204a,b-n.

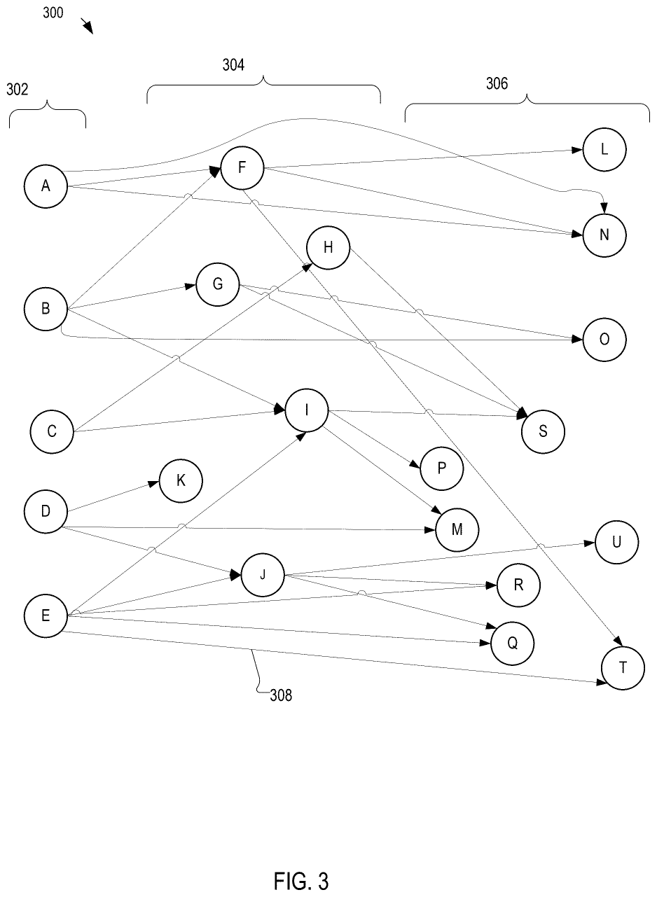

In order to generate a transportation network solution, a graph neural network representation of a particular transportation network may be generated. Accordingly, FIG. 3 sets forth an example graph neural network representation 300 of a particular example transportation network for generating transportation network solutions using graph neural networks in accordance with some embodiments of the present disclosure. A graph neural network representation 300 of a transportation network is a graph neural network encoding of the various entities and relationships in a product transportation network as described above. The approaches set forth herein may be applicable to any type of graph neural network as can be appreciated provided that the particular graph neural network is capable of performing predictions or classifications on nodes and edges, described in further detail below. In some embodiments, a graph neural network representation 300 of a product distribution network may be generated based on input data describing the product distribution network. For example, in some embodiments, one or more software libraries such as Pytorch, Tensorflow, and the like may be used to generate a graph neural network representation 300 of a product distribution network. Such libraries may include functions that accept input data (e.g., the data describing the product distribution network) to generate a graph neural network representation 300. The input data describing the product distribution network may indicate any of the aspects of a transportation network as described herein. Various data points in this input data may be used to generate the nodes and edges of the graph neural network representation 300 as well as their respective features.

The graph neural network representation 300 includes source nodes 302, shown using labels A, B, C, D, and E. Each source node 302 may correspond to a particular plant 202a-n or other source of products in a transportation network as can be appreciated. The graph neural network representation 300 also includes multiple intermediary nodes 304. The intermediary nodes 304 are shown as having labels F, G, H, I, J, and K. Each intermediary node 304 serves as an intermediary between one or more source nodes 302 and one or more destination nodes 306. Accordingly, each intermediary node 304 may correspond to a distributor 204a,b-n or another intermediary for products in a product transportation network as can be appreciated. The graph neural network representation 300 also includes multiple destination nodes 306. The destination nodes 306 are shown as having labels L, M, N, O, P, Q, R, S, T, and U. Each destination node 306 may correspond to a particular dealer 206a,b, c-n or other destination for products of a product transportation network as can be appreciated.

The graph neural network representation 300 also includes multiple edges 308 each interconnecting a source node 302 and an intermediary node 304, an intermediary node 304 and a destination node 306, or a source node 302 and a destination node 306. Each edge 308 may correspond to a route 208 of a product transportation network. As shown each edge 308 includes a directed edge between a pair of nodes.

In some embodiments, the source nodes 302, intermediary nodes 304, destination nodes 306, and/or edges 308 may include one or more features (e.g., node features and/or edge features). Each of these features may correspond to or describe an attribute of the entity represented by the corresponding node or edge. Such features may be used in performing a graph neural network prediction based on the graph neural network representation 300, to be described in further detail below. As an example, features of source node 302 may indicate which products are manufactured at a corresponding plant 202a-n. As another example, features of an intermediary node 304 may indicate available modes of transportation to or from the corresponding distributor 204a,b-n, a minimum or maximum capacity of the corresponding distributor 204a,b-n, and the like. As a further example, features of a destination node 306 may indicate various rules or requirements for the corresponding dealer 206a,b, c-n, such as particular products and/or brands required, particular plants 202a-n from which products and/or brands should be sourced, particular amounts for required products and/or brands, combinations thereof, and the like. As yet another example, features of an edge 308 may indicate, for a corresponding route 208, a transportation distance, a transportation mode (e.g., highway, railway, seaway), amounts of required lead time, transportation costs, and the like.

The graph neural network representation 300 of the product transportation network may then be used to generate an initial state for performing a model optimization. Particularly, the graph neural network representation 300 may be used to perform a graph neural network prediction. The graph neural network prediction is a binary classification problem whereby a label is assigned to each node (e.g., each source node 302, intermediary node 304, and destination node 306) and each edge 308 indicating whether or not the labeled entity is predicted to be included in a subsequently generated transportation network solution. Put differently, the graph neural network prediction includes binary classifications applied to the nodes and edges 308 of the graph neural network representation 300, with each binary classification being a prediction as to whether the corresponding edge 308 or node is included in the subsequently generated transportation network solution. In some embodiments, the graph neural network prediction may be facilitated by one or more software libraries used to perform graph neural network predictions such as Pytorch, Tensorflow, and the like. For a binary classification, classes are established of ‘included’ (e.g., “1”) and ‘not included’ (e.g., “0”) for the prediction task.

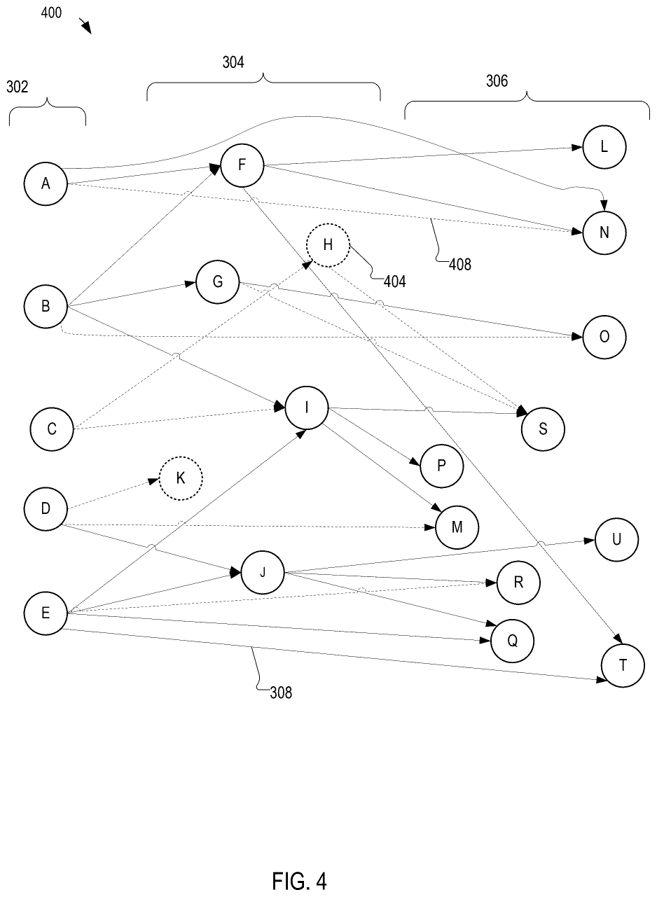

Accordingly, FIG. 4 sets forth a diagram of an example graph neural network prediction 400 for generating transportation network solutions using graph neural networks in accordance with some embodiments of the present disclosure. The graph neural network prediction 400 is similar to the graph neural network representation 300, differing in that a subset of the intermediary nodes 304 and edges 308 are depicted as predicted from being excluded from the subsequently generated transportation network solution. Such excluded intermediary nodes 304 and edges 308 are shown using dotted lines. For example, edge 408a linking source node 302 A to destination node 306 N is predicted (e.g., labeled) to be excluded. As another example, intermediary node 404 H, and by extension any linked edges 308, are predicted to be excluded.

In some embodiments, performing the graph neural network prediction 400 includes providing, as input to the graph neural network (e.g., using libraries or other interfaces for interacting with the graph neural network), classification instructions. Such classification instructions may include indications of particular nodes and/or edges to be classified or predicted. Where a particular node or edge is not indicated for classification or prediction in the classification instructions, these nodes or edges may be automatically included or excluded from the graph neural network prediction 400 (e.g., automatically assigned a classification of inclusion or exclusion). Such classification instructions may also include indications of particular transportation modes that may be included in the prediction (e.g., land, sea, air, and the like). For example, in embodiments, where the classification instructions indicate particular transportation modes that may be included, those transportation routes (e.g., edges 308) of other transportation modes may be automatically excluded from the graph neural network prediction 400. Classification instructions may also for some embodiments include the establishing of the possible classes for the prediction of ‘included’ (e.g., “1”) and ‘not included’ (e.g., “0”) for the prediction task.

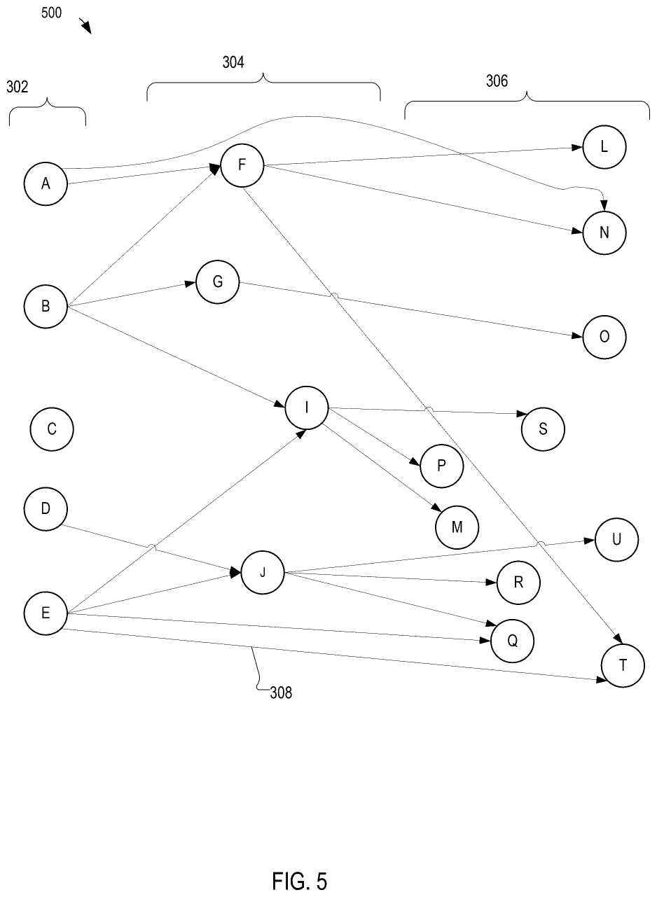

The graph neural network prediction 400 effectively pre-prunes the graph neural network representation 300, thereby generating a pruned model 500 as shown in FIG. 5. Particularly, the graph neural network prediction 400 pre-prunes the graph neural network representation 300 by effectively removing those edges 308 and nodes predicted to not be included in the transportation network solution. The pruned model 500 serves as an initial state for a model optimization operation to generate a transportation network solution. As referred to herein, a model optimization operation (e.g., optimization modeling) optimizes a mathematical model including multiple variables and an objective function. Performing the model optimization operation includes determining an optimal combination of values for these multiple variables that minimizes or maximizes the particular objective function. For example, in some embodiments, performing the model optimization operation includes determining values for variables so as to minimize a total cost function for transporting products across a product transportation network. In some embodiments, the model optimization operation may include one or more constraints. For example, in some embodiments, the model optimization operation may include constraints defining the various requirements of dealers described above. Thus, performing the model optimization operation may include determining values for variables based on some objective function while satisfying one or more constraints.

Here, the variables of the model optimization operation may correspond to the nodes and edges 308 of the pruned model 500. By removing some number of nodes and/or edges 308 to generate the pruned model 500, the model optimization operation will include fewer variables than a model optimization operation corresponding to the unpruned graph neural network representation 300. For example, in some embodiments, the variables of the model optimization operation may include, for each edge 308, how much of a particular product will be transported between the interconnected nodes (e.g., between the entities corresponding to the interconnected nodes via the route 208 corresponding to the edge 308). In solutions where the model is not pre-pruned as described above, the computational complexity of the model optimization operation is significantly increased. For example, in some solutions, the model optimization operation may include additional variables indicating whether particular intermediary nodes 304 or edges 308 will be included in the solution to the model optimization operation. As another example, the number of variables to be solved will be increased due to the inclusion of additional intermediary nodes 304 and edges 308. Instead, by using the pruned model 500 as the initial state for the model optimization operation and removing these additional variables, the overall computational complexity in generating the transportation network solution is reduced. Thus, an information set representing nodes and edges of the pre-pruned model are the inputs to another optimization function to perform the model optimization. In response to this inputting of the information set, the model optimization produces an output with a desired set of optimized values.

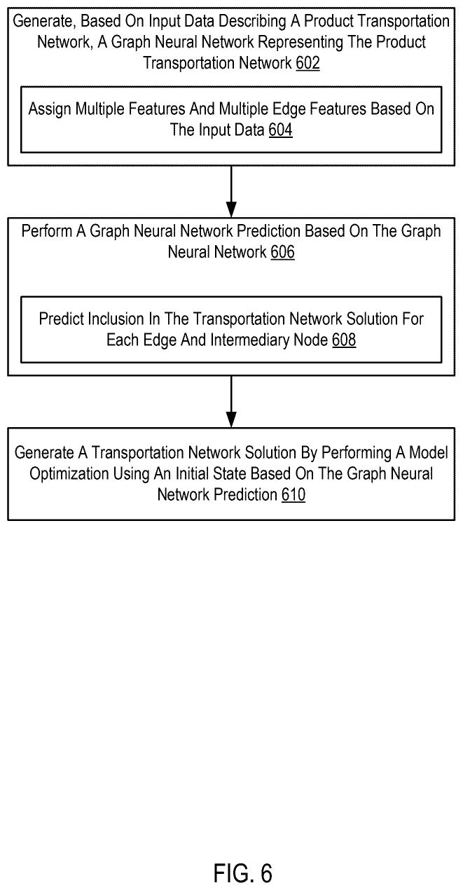

For further explanation, FIG. 6 sets forth a flowchart of an example method of generating transportation network solutions using graph neural networks in accordance with some embodiments of the present disclosure. The method of FIG. 6 may be performed, for example, by the transportation planning module 107 of FIG. 1. The method of FIG. 6 includes generating 602, based on input data describing a product transportation network, a graph neural network representing the product transportation network. The input data may describe various aspects of a product transportation network and may be encoded according to a variety of approaches. For example, in some embodiments, the input data may indicate one or more plants 202a-n or other sources for products. As another example, in some embodiments, the input data may indicate one or more dealers 206a,b, c-n for receiving products. As a further example, in some embodiments, the input data may indicate one or more distributors 204a,b-n or other intermediaries between plants 202a-n and dealers 206a,b, c-n. As a further example, in some embodiments, the input data may indicate one or more routes 208 for transporting products between plants 202a-n, distributors 204a,b-n, and dealers 206a,b, c-n.

Accordingly, in some embodiments, generating 602, based on the input data, the graph neural network may include generating a graph encoding of the product transportation network based on the input data. In some embodiments, each plant 202a-n or source for products in the input data may be represented as a source node 302 in the graph neural network. In some embodiments, each distributor 204a,b-n or other product intermediary may be represented as an intermediary node 304 in the graph neural network. In some embodiments, each dealer 206a,b, c-n or other product recipient may be represented as a destination node 304 in the graph neural network. In some embodiments, each route 208 connecting a pair of entities may be represented as an edge 308 connecting a pair of nodes corresponding to the pair of entities.

In some embodiments, the input data may describe various attributes or parameters for the plants 202a-n, distributors 204a,b-n, dealers 206a,b, c-n, and routes 208. For example, in some embodiments, the input data may describe, for one or more plants 202a-n, one or more produced products. As another example, in some embodiments, the input data may describe, for one or more distributors 204a,b-n, minimum or maximum product capacities (e.g., capacity limits). As a further example, in some embodiments, the input data may describe, for one or more dealers 206a,b, c-n, one or more product demands including particular products to be received, amounts of those products to be received, particular plants 202a-n from which products should be sourced, particular quantities of products to be sourced from particular plants 202a-n, and the like. As yet another example, the input data may describe, for one or more routes 208, one or more transportation route attributes including a transportation distance, a transportation cost, a particular mode of transportation, and the like.

In some embodiments, these attributes or parameters may be encoded or included in the graph network as features of their corresponding nodes or edges 308 (e.g., as node features or edge features). Accordingly, in some embodiments, generating 602, based on input data describing a product transportation network, a graph neural network representing the product transportation network may include assigning 604 multiple node features and multiple features based on the input data. In some embodiments, generating 602 the graph neural network may be facilitated using one or more dedicated software libraries such as Python or Tensorflow, or using other libraries or applications as can be appreciated. Such libraries or applications may accept input data (e.g., input data describing the transportation network) and generate, from the input data, a graph neural network.

The method of FIG. 6 also includes performing 606 a graph neural network prediction based on the graph neural network. In some embodiments, the graph neural network prediction may be performed 606 using one or more of the software libraries or applications set forth above for generating the graph neural network. In some embodiments, performing 606 the graph neural network prediction includes performing a binary classification on each edge 308 and intermediary node 304 of the graph neural network. In some embodiments, performing 606 the graph neural network prediction also includes performing a binary classification on each source node 302 of the graph neural network. The binary classification may indicate a prediction as to whether the corresponding edge 308 or node will or will not be included in the transportation network. In other words, in some embodiments, performing 606 a graph neural network prediction based on the graph neural network includes predicting 608 inclusion in the transportation network solution for each edge and each intermediary node 304 and/or source node 304. In some embodiments, performing 606 the graph neural network prediction may be based on a Softmax layer or other layer of the graph neural network used for classification or prediction.

In some embodiments, performing 606 the graph neural network prediction effectively prunes the graph neural network by removing those edges and/or nodes predicted to not be included in the transportation network solution. This removes variables from a model optimization operation for generating the transportation network solution, thereby reducing the overall computational complexity of performing a model optimization as described above. For example, a pruned model may exclude any source node 302, intermediary node 304 and/or edge 308 predicted to not be included in the transportation network solution.

The method of FIG. 6 also includes generating 610 a transportation network solution by performing a model optimization using an initial state based on the graph neural network prediction. In some embodiments, generating 610 the transportation network solution by performing the model optimization may be performed automatically in response to performing 606 the graph neural network prediction. In some embodiments, generating 610 the transportation network solution by performing the model optimization may be performed in response to a command or request to generate 610 the transportation network based on the graph neural network prediction, such as by providing the graph neural network as input to some software or function configured to perform the model optimization.

Performing a model optimization (e.g., optimization modeling) includes optimizing a mathematical model by determining values for one or more variables based on an objective function (e.g., to minimize or maximize an objective function). In some embodiments, the one or more variables may correspond to those nodes and/or edges 308 predicted to be included in the transportation network solution according to the graph neural network prediction. As these variables correspond to a subset of the nodes and/or edges 308 of the original graph neural network, the model optimization uses fewer variables than a model optimization applied to variables corresponding to the original graph neural network. In some embodiments, the model optimization may be performed using any appropriate software, library, or application for model optimizations as can be appreciated.

For example, in some embodiments, performing the model optimization may include determining values for one or more variables to minimize a cost function (e.g., a transportation cost function) for transporting products from plants 202a-n to dealers 206a,b, c-n as represented in the graph neural network. In some embodiments, these one or more variables may include, for each edge 308 (e.g., for each route 208 represented in the graph neural network), an amount of a particular product to be transported between the linked nodes (e.g., between the entities represented by the linked nodes). As is set forth above, by effectively pre-pruning the model to be optimized (e.g., the graph neural network), the number of variables to be considered in the model optimization is reduced, thereby reducing overall computational complexity of performing the model optimization.

The resulting transportation network may then reflect the solution (e.g., the defined variables) for the model optimization. For example, the resulting transportation network may indicate amounts of products to be transported from each plant 202a-n to one or more distributors 204a,b-n and/or dealers 206a,b, c-n, amounts of products to be transported from each distributors 204a,b-n to one or more dealers 206a,b, c-n, particular routes 208 to be used when transporting these products, and the like.

In some embodiments, the generating 610 of the transport network solution includes outputting the recommendation and/or output of the model optimization, e.g., via an output device of a computer communicatively connected to the model. For example, the solution is displayed on a display screen of the UI device set 123 of the computer 101 shown in FIG. 1. In some embodiments, generating 610 of the transport network solution includes transmitting automated computer control instructions to control machines and/or equipment to effectuate a change of the recommendation and/or output of the model optimization. For example, automated computer control instructions are transmitted to loading robots at one of the locations to load different amounts of goods into a transportation component such as a truck. In another example, automated computer control instructions are transmitted to loading equipment to clear storage area for receiving goods that are delivered via the transportation network. In some embodiments, these instructions are transmitted to automated equipment to cause more space to be generated, e.g., by moving other materials to other locations. In some embodiments, these instructions to the automated equipment indicate that less space is needed so that other goods are loaded via automated equipment into some space that was initially designated for a different good. In some embodiments, the model recommendation/output is transmitted to end user devices 103 at other locations within the transportation network for presentation at those other locations.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
generating, based on input data describing a product transportation network, a graph neural network representing the product transportation network, wherein the graph neural network comprises multiple edges, multiple source nodes, multiple destination nodes, and multiple intermediary nodes;
performing a graph neural network prediction based on the graph neural network, wherein performing the graph neural network prediction comprises predicting inclusion in the transportation network solution for each edge and intermediary node; and
generating a transportation network solution by performing a model optimization using an initial state based on the graph neural network prediction.

2. The method of claim 1, wherein the multiple intermediary nodes each interconnect a respective subset of the multiple source nodes to a respective subset of the multiple destination nodes.

3. The method of claim 1, wherein generating the graph neural network comprises assigning multiple node features and multiple edge features based on the input data.

4. The method of claim 3, wherein the multiple node features comprise one or more product demands for one or more of the multiple destination nodes.

5. The method of claim 3, wherein the multiple node features comprise one or more produced products for the multiple source nodes.

6. The method of claim 3, wherein the multiple node features comprise one or more capacity limits for one or more of the multiple intermediary nodes.

7. The method of claim 3, wherein the multiple edge features comprise transportation route attributes for the multiple edges.

8. The method of claim 1, wherein the model optimization is based on an objective function.

9. The method of claim 1, wherein the model optimization is based on one or more constraints.

10. A computer system comprising:
a processor set;
one or more computer-readable storage media; and
program instructions stored on the one or more storage media to cause the processor set to perform operations comprising:
generating, based on input data describing a product transportation network, a graph neural network representing the product transportation network, wherein the graph neural network comprises multiple edges, multiple source nodes, multiple destination nodes, and multiple intermediary nodes;
performing a graph neural network prediction based on the graph neural network, wherein performing the graph neural network prediction comprises predicting inclusion in the transportation network solution for each edge and intermediary node; and
generating a transportation network solution by performing a model optimization using an initial state based on the graph neural network prediction.

11. The computer system of claim 10, wherein the multiple intermediary nodes each interconnect a respective subset of the multiple source nodes to a respective subset of the multiple destination nodes.

12. The computer system of claim 10, wherein generating the graph neural network comprises assigning multiple node features and multiple edge features based on the input data.

13. The computer system of claim 12, wherein the multiple node features comprise one or more product demands for one or more of the multiple destination nodes.

14. The computer system of claim 12, wherein the multiple node features comprise one or more produced products for the multiple source nodes.

15. The computer system of claim 12, wherein the multiple node features comprise one or more capacity limits for one or more of the multiple intermediary nodes.

16. The computer system of claim 12, wherein the multiple edge features comprise transportation route attributes for the multiple edges.

17. The computer system of claim 10, wherein the model optimization is based on an objective function.

18. A computer program product comprising:
one or more computer-readable storage media; and
program instructions stored on the one or more storage media to perform operations comprising:
generating, based on input data describing a product transportation network, a graph neural network representing the product transportation network, wherein the graph neural network comprises multiple edges, multiple source nodes, multiple destination nodes, and multiple intermediary nodes;
performing a graph neural network prediction based on the graph neural network; and
generating a transportation network solution by performing a model optimization using an initial state based on the graph neural network prediction.

19. The computer program product of claim 18, wherein the multiple intermediary nodes each interconnect a respective subset of the multiple source nodes to a respective subset of the multiple destination nodes.

20. The computer program product of claim 18, wherein generating the graph neural network comprises assigning multiple node features and multiple edge features based on the input data.
